(19) United States
(12) Patent Application Publication
(10) Pub. No.: US 2004/0079353 A1
(43) Pub. Date: Apr. 29, 2004

(54) Roaster with cover

(76) Inventor: Panagopoulos Dimitrios, Athens (GR)

Correspondence Address: Dimitrios Panagopoulos, Ksiropigadou Str 19600, Mandra Attica, GR

(21) Appl. No.: 10/469,872

(22) PCT Filed: Mar. 7, 2002
(86) PCT No.: PCT/GR02/00012

(30) Foreign Application Priority Data
Mar. 8, 2001 (GR) 20010100109

(51) Int. Cl. A47J 37/06

(52) U.S. Cl. 126/19 R; 219/386

(57) ABSTRACT

The roaster consists of: cover 1, the wire grill 2, control 3, base 4 designed to accept the water container and can accommodate aluminum plate covered with PTF TEFLON.

The invention refers to a domestic use roaster and has been designed, to include basic new parts that facilitate its use and operation and achieve better results than the roasters that have been manufactured so far and have several disadvantages and problems.

These problems guided to the effort of inventing technical solutions and the first objective of this invention is to present a domestic roaster with the following advantages.

Another innovation of the subject invention, is that it overcomes problems having to do with endurance, operation and life limit, by applying several construction solutions, witch will be presented in detail herein and all the above mentioned will be revealed among other advantages of this appliance.

The specialists of this technique will understand the invention studying the attached drawings:

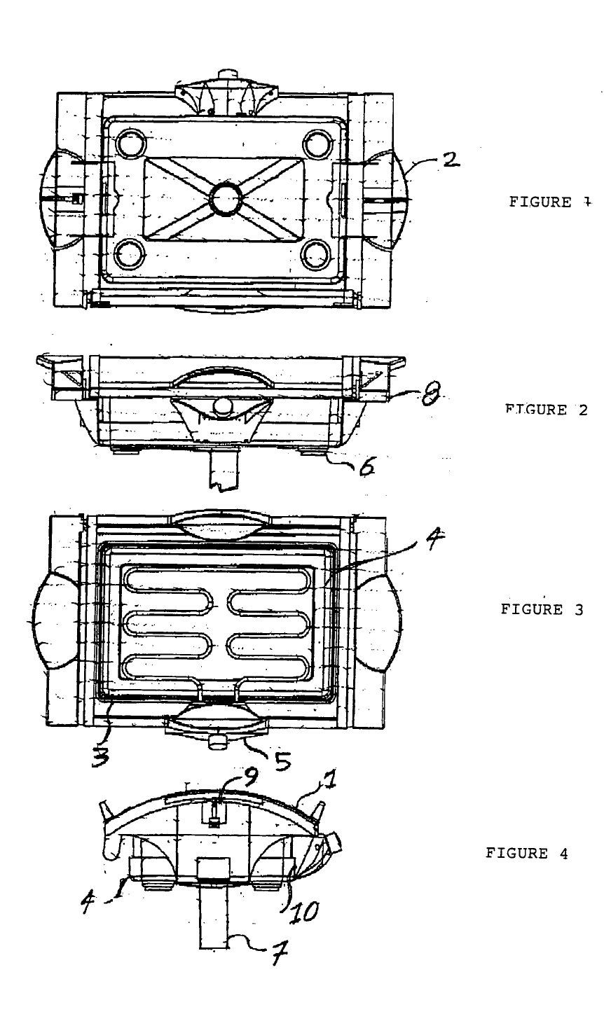

FIG. 1: Roaster's inside view.

FIG. 2: Main body's side view.

FIG. 3: Electrical Resistance's view.

FIG. 4: External Side view.

Regarding to an indicating selected example of an industrial application of the invention, a description of the main parts in respect to the attached drawing numbers is given below. The drawings are not under scale but there is size proportion of the parts shown.

According to the indicating selected application of the invention the main parts of it are:

1. Cover of the appliance, which covers the device preventing thermal losses during cooking. There is a parallel adjustment of the cover, allowing it to move vertically. In this way the cooking area is getting bigger to accommodate different sizes of food such as chicken etc. The cover can be removed when in a vertical position (90°), using the two handles (one to the front and one to the rear of the device) and pulling upwards. Then the cover can be cleaned in a dishwasher or anywhere else. Additionally the whole appliance can be disassembled and be cleaned in a dishwasher.

2. Wire grill with two handles, which are seated on two specially-designed fittings placed on the left and right of the appliance.

Underneath each of these fittings, there is a lever that can be adjusted vertically so as to change the distance between the electrical resistance and the grill to achieve the kind of roasting we wish. They can be disassembled and washed separately in a dishwasher or else.

3. Aluminum Plate covered with PTF TEFLON. After taking out the appliance the wire grill, the aluminum plate can be installed in a way that enables to be in contact with the electrical resistance. (It can also be placed over the wire grill and so the distance from the electrical resistance can be adjusted.)

4. Aluminum container. It is placed beneath the electrical resistance on a plastic base. Inside the container water is poured up to the indicated MAX level. During cooking the water is evaporated due to high temperature. For safety reasons, in the case of partial or full evaporation of the water, there is a spring with a lever under the container, ending to a micro switch, which is fitted inside the control panel turning the appliance ‘ON’ or ‘OFF”, depending on the water level. The power will be turned ‘ON’ only when the water is up to the ‘MAX’ level, the spring is pressed downwards moving the lever in such a way as to turn the power ‘ON’.

This safety system prevents the appliance from overheating, or even fire, if the device is forgotten plugged.

5. Control. Inside the control is fitted the tubular electrical resistance. At the front side of the resistance with the electrical contacts, there is a metallic plate that connects the two resistance ends and is embodied in it. On each side of this plate there are fitted two plastic accessories appropriately designed in order to:

a) Hold the resistance in the control.

b) Prevent the heating of the control from the resistance. For this reason this plate is made of special thermoplastic material.

For better control of the heating, the thermostat of the appliance is inserted in the middle of the plate with a bolt and a nut. The thermostat is equipped with an axis ending to the knob of the appliance regulating the heating. There is a receptacle on this knob for the axis to fit in, and another one (receptacle) for the indicating lamp, so in this way the whole knob illuminates when the resistance is ‘ON’.

Inside the control and on its lower part there is a microswitch that controls the power to the device, depending on the amount of the water in the container and on the correct installation of this container.

Finally to the control and through the lower part of the appliance the electrical power cable is inserted and it is appropriately connected to the thermostat, the microswitch, the indicating lamp and the electrical resistance.

6. Appliance Base. The base is specially designed to accommodate the water container. In the front side of the base there are two fittings made in such way as to facilitate the easy insertion of the control. On each side of the base there are two cavities appropriately designed in order to support the two side panels of the appliance. All these form the main frame of the whole invention. These panels can be easily removed for washing purposes. On the lower part of the base and in its centre there is an appropriate circular fitting for base “leg support” to fit in when the appliance has to be used in a place where there is no table, or any other elevated work surface available.

7. Columns. In an intermediate level between the base and the “support leg” there is a utility plastic container, on which there are receptacles to accommodate the columns.

Salt, pepper, and other cooking accessories can be stored on it.

All the above-mentioned parts of the appliance can be disassembled for washing and storage purposes. At the lower part of the appliance and at the end of the columns there are the five “end-supports” of the roaster, which consist of a circular plastic part in which there are fittings to accommodate the “support leg” on its top and the end supports on its lower side. These parts can also be disassembled easily for washing and storage purposes.

8. Cover Panels, left and right.

They consist of four parts:

a) Two of them are fitted on the two sides of the main frame. The side panels of the main frames are properly shaped and there are two cavities on either side in order to facilitate easy assembly and movement of the cover. The cover moves up and down either when it is in a vertical or horizontal position. While in the vertical position, it can be disassembled, just by pulling it, for washing purposes.

b) The other two parts are equipped each with a handle to facilitate the handling of the cover.

9. Receptacles in the middle in which there are:

a) The levers that change the distance between the wire grill and the electrical resistance.

b) Plastic handles, which fit on the wire grill so heat does not affect them.

10. Microswitch Safety Lever. At the front side of the base of the appliance, between the two control fittings, there is a specially designed plastic part, one end of which is fitted in the base and on the other end the water container is placed, while one spring is attached to. In this way, when the water container is empty, it is slightly elevated and at the same time the spring and this plastic part activate the safety microswich turning the main power “OFF”, preventing possible fire.

It must be noted that the described invention can be constructed and in another way. It can be constructed by using different production methods, parts and mechanisms but always under the same idea and design.

1. A domestic roaster featuring closing cover preventing thermal losses. The cover can be easily removed and can be put in a dishwasher.

2. A roaster under the above claim 1, featuring wire grill with two handles that can be adjusted vertically using two levers.

3. A roaster under the above claim 1, featuring alternative use of an aluminum plate covered with PTF TEFLON.

4. A roaster under the above claim 1, featuring water container, in order to prevent the roaster from overheating.

5. A roaster under the above claim 1, featuring control with tubular electrical resistance.

6. A roaster under the above claim 1, featuring base designed to accept the water container.
